(19) United States
(12) Patent Application Publication
(10) Pub. No.: US 2005/0055715 A1
(43) Pub. Date: Mar. 10, 2005

(54) Method and apparatus for updating television recording timers

(75) Inventors: Dan Minnick, Littleton, CO (US); Stephen David Bartlett, Larkspur, CO (US)

Correspondence Address: MERCHANT & GOULD PC, P.O. BOX 2903, MINNEAPOLIS, MN, 55402-0903, US

(73) Assignee: EchoStar Technologies Corporation

(21) Appl. No.: 10/655,703

(22) Filed: Sep. 5, 2003

(51) Int. Cl. H04N 7/16; G06F 13/00; H04N 5/445; G06F 3/00

(52) U.S. Cl. 725/58; 725/61; 725/52; 725/53

(57) ABSTRACT

The present invention allows the user to correctly record every episode of a recurring program by updating the timing of the record for the instances of the recurring program. In addition, the present invention allows the user to record multiple episodes of a television program shown on one or more channels, regardless of when these episodes will play. The present invention also ensures that identical episodes are not recorded.

### FIELD OF THE INVENTION

The present invention relates to television recording devices for receiving and recording channels of television programming. More particularly, the invention relates to a method and apparatus for setting timers used to record multiple episodes of a television program.

### BACKGROUND

Various devices exist that can be used to record television programs. Most common are VCRs, which can record television programs. More recently, devices known as personal video recorders (PVRs) have entered the market. PVRs use a hard drive to record digital data that represents a television program. Various optical media and other forms of memory can be used to record television programs or digital representations thereof.

The aforementioned television recording devices can be used to automatically record programs that will occur in the future. For VCRs, one can input the channel, time, and duration of a program to be recorded. This can be referred to as the manual setting of a timer. Newer PVR devices allow a user to select a television program to be recorded from an electronic program guide (EPG). An EPG is a display of program and schedule information on the television screen. Such information can be broadcast to the television recording device, and can be periodically updated. Advanced EPGs allow users to highlight particular programs. If selected, by pressing the proper button on a remote control, a timer can be created for the highlighted program for either watching or recording.

Some advanced EPGs allow the user to set recurring timers. There are timers that trigger a record on a periodic basis. For example, a user could set the television recording device to record ABC (or any channel) every Sunday at 8:00 p.m. for one hour. Such “recurring” timers can be for the same channel and time period every week, everyday, or on weekdays.

Another feature of some prior art EPGs is the ability to update a non-recurring timer. In this type of device, a user can select a program to be recorded in the future. If the scheduled time for that program is thereafter changed, the timer can be updated accordingly. Such systems utilize an identifier unique to each program in the EPG to identify the program to be recorded. The television recording device can then use that unique identifier, sometimes referred to as an “event ID”, to periodically check the EPG database to see if the schedule time of the program to be recorded has changed. The timer can then be updated accordingly.

Prior art devices, however, do not provide for the updating of recurring timers. Further, prior art devices do not provide for the recording of multiple episodes of a television program that do not reoccur at the same time periodically. In addition, the prior art can end up recording identical episodes of the same television program thereby wasting valuable recording space. These and other deficiencies of the prior art are overcome by the present invention.

### BRIEF SUMMARY OF THE INVENTION

The present invention allows the user to correctly record episodes of a recurring program by updating the timing of the record for the instances of the recurring program. In addition, the present invention allows the user to record multiple episodes of a television program shown on one or more channels, regardless of when these episodes will play. The present invention also ensures that identical episodes are not recorded. These conflicts are displayed graphically for the user to resolve. Other features and advantages of the present invention will become apparent from the following detailed description of the invention and the accompanying drawings.

### BRIEF DESCRIPTION OF THE SEVERAL VIEWS OF THE DRAWINGS

FIG. 1 is a high level block diagram of an entertainment system using a television receiving device and a universal remote control of an embodiment the present invention.

FIG. 2 is a high level block diagram of a television receiving device of an embodiment of the present invention.

FIG. 3 is a flow diagram illustrating a method for updating a recurring timer for a recurring television program.

FIG. 4 s a flow diagram illustrating a method for creating timers for the recording of episodes of a program.

For clarification, the drawings use a nomenclature for reference numerals that has two parts. The first part of the reference numeral is the drawing number, and it is followed by the second part, a two digit identifier (drawing 1 uses 1xx; drawing 3 uses 3xx). For example, two reference numerals in drawing 1 may be “102” and “104.” A reference numeral in one drawing may be referred to in subsequent drawings; the same reference numeral in later drawings refers to the same item.

### DETAILED DESCRIPTION OF THE INVENTION

In this specification, the present invention will be described using methods and systems related to subscriber satellite television service. This specific description is not meant to limit the invention to that one embodiment. The present invention may also be applicable to cable television systems or other television systems. One skilled in the art will recognize that the present invention can apply elsewhere.

As a general matter, the disclosure uses the term “signal.” One skilled in the art will recognize that a signal may be any digital or analog signal. Those signals may include, but are not limited to, a bit, a specified set of bits, an A/C signal, or a D/C signal. Uses of the term signal in the description may include any of these different interpretations. It will also be understood to one skilled in the art that the term “connected” is not limited to a physical connection but can refer to any means of communicatively or operatively coupling two devices.

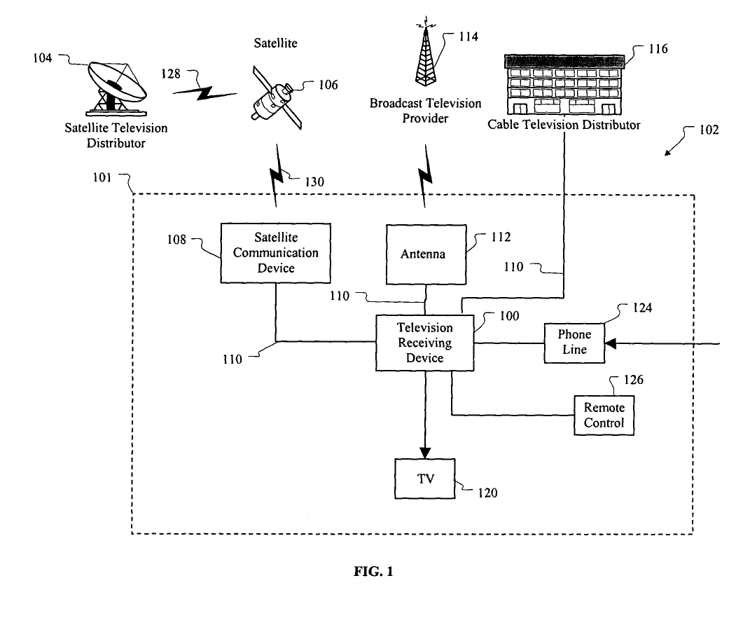

FIG. 1 presents an embodiment of a home entertainment system 101 that includes a television receiving device 100 that may be connected to a cable television distributor 116, an antenna 112 that can receive broadcast signals from a broadcast television provider 114, a satellite communication device 108, a remote control 126, a phone line connection 124, and one or more peripheral electronic devices that may include a television 120.

The television receiving device 100 may be any of a plurality of commercial television receivers, for instance, satellite set-top-boxes or personal video recorders, referred to herein generally as television recording devices. Although television receiving devices 100 are normally self-enclosed units, one skilled in the art will recognize that a television receiving device 100 may be implemented as several separate units or could be included within a television. An example of a combined satellite set-top-box and a personal video recorder would be the Echostar DishPVR 721, part # 106525. For the remainder of this disclosure, specific embodiments of a home entertainment systems 101 with a satellite set-top-box 100 will be described.

Generally, the satellite set-top-box 100 may receive television signals directly from a cable television distributor 116, from a broadcast television provider 114, via the antenna 112, or from a satellite television distributor 104. The satellite set-top-box 100 may process those television signals and can send the processed signals to the peripheral electronic devices. The satellite set-top-box 100 also may accept commands from a remote control 126. More detail about the functionality of the satellite set-top-box 100 is provided below.

To further describe the home entertainment system, embodiments relating to receiving satellite television signals will be explained in more detail. A satellite television distributor 104 transmits one or more satellite television signals 128 to one or more satellites 106. Many satellite television services utilize several satellites 106 to relay the satellite television signals to a subscriber. Each satellite 106 may have several transponders. Transponders transmit the signal 130 from the satellite to the subscriber. These signals 130 can be transmitted at a frequency of 2150 Mhz.

A transponder may also polarize the transmitted signal 130 in several ways. One form of polarization in satellite transmissions is circular polarization. With many satellites 106, the transponders may transmit together two signals on the same transponder, one signal that is right-hand polarized and another signal that is left-hand polarized. In other words, two signals are simultaneously transmitted with opposite polarizations. The opposite polarizations prevent interference.

The polarized signals can be received at the satellite communication device 108. The satellite communication device 108 may include one or more of the items that follow. One component may be a circular satellite dish. A satellite dish can focus the signal on one or more low-noise block filters (LNBF). The LNBFs can de-polarize and initially process the signal. In most cases, the initial processing may include filtering noise from the signal and down-converting the signal. Down-conversion is sometimes required to transmit the signal 110 through certain cables, such as coaxial cables. The signal 110 arrives at the television receiver 100 via the cabling. One skilled in the art will recognize that other methods and other systems of delivering the satellite signal 110 to the satellite set-top-box may be possible.

The signal 110 that arrives at the satellite set top box 100 may undergo extensive processing. One of the first steps maybe to demodulate the signal 110. The signal 110 may arrive as an analog signal that “carries” data, i.e., there is data modulated onto the analog signal. Demodulation may be done by reversing the modulation process. Modulation can be done in several ways. Common forms of modulation may include amplitude modulation (AM) or frequency modulation (FM). If the carried data is digital, some of the more common methods used may be biphase-shift keying (BPSK), quadraphase-shift keying (QPSK), or eight phase shift keying (8PSK). One skilled in the art will recognize that other methods of modulating and demodulating the signal 110 may be possible. For the purposes of discussion, an embodiment using digital data will be discussed below. However, one skilled in the art will recognize that systems with analog data or combined analog and digital data are also possible and contemplated.

After demodulation, the signal is in digital form. The digital stream may be multiplexed and thus require demultiplexing. Demultiplexing, or demuxing, may include separating the bits of data into separate digital data streams. The digital streams may be packetized. Thus, the multiplexing of the separate digital data streams may not be bit-by-bit but packet-by-packet. The packet size may vary. After demuxing the packets, the separate digital data streams may be reassembled by placing related packets together in a continuous data stream.

Each of the separate digital data streams may also be encoded. Encoding is a method for representing data. Normally, encoding can allow the data to be compressed. Compression provides the system with increased bandwidth. There are several different formats that can be used for encoding. In satellite television, the more common methods of encoding may include the MPEG or MPEG2 standards. Beyond the raw data, the separate digital data streams may include forward error correction, headers, checksums, or other information. All of this different information may be included in each separate digital television signal processed by the satellite set-top-box 100.

Each separate digital television signal may represent the signal from a single service provider. A service provider is a television signal from a “broadcaster.” Some examples of these service providers include HBO™, CSPN™, ABC™, CBS™, or ESPN™. In satellite television, a service provider can also be compared to a “channel.”

The term channel as used in this description carries a different meaning from its normal connotation. In broadcast television, different analog signals are carried on sub-channels of a carrier frequency. A tuner in a television would acquire and process these sub-channels. Each sub-channel would include the analog signal of a television station. The term channel has become synonymous with the sub-channel or the station on that sub-channel.

Satellite television signals 120 are very different. These signals are multiplexed, packetized, and modulated digital signals. One modulated, analog satellite transmission may carry data representing several television stations. Thus, the term channel is not appropriate to describe satellite television transmissions. However, satellite television providers can organize the satellite data into a group of different “virtual channels.” These virtual channels give the impression that the satellite television programs (the service providers) are placed in channels. However, this impression assists the user operate the satellite set-top-box 100 since it models, but does not functions like, an analog television or analog receiving device. The virtual channels appear in the EPG data and the user selects programming by selecting a virtual channel. For instance, the user can select HBO, which may be on virtual channel 120, or CSPAN, which may be on virtual channel 45. These service providers or virtual channels are not necessarily carried in the same signal 120 being sent from the same satellite. Thus, in satellite television service a channel is not the same as in broadcast television service, rather, channels may be more properly termed service providers. The term channel will be used in this description to describe the service providers and the virtual channels they occupy.

The home entertainment system 101 may also include a remote controller 126, also sometimes referred to as a remote control or, simply, a remote. The remote control 126 may be used to send commands to the satellite set-top-box 100, usually via a wireless connection using infrared or UHF transmitters within the remote control 126. One example of an embodiment of a remote controller 126 is the EchoStar Technologies Corporation 721. Platinum Plus Remote, part # 121150, which has a pair of transmitters, an IR transmitter and an ultra high frequency (UHF) transmitter. The remote control 126 may be able to send signals to other peripheral electronic devices that form part of the home entertainment system 101 such as the television, a stereo, a VCR, or a DVD player. In some embodiments, the remote control 126 has a set of Light Emitting Diodes (LED). Some remote control may include Liquid Crystal Displays (LCD) or other screens. The remote control may include buttons, dials, or other man-machine interfaces.

While the remote control 126 is the common means to communicate with the satellite set-top-box 100, one skilled in the art will recognize that there are other means available, including, but not limited to attached keyboards or touch screens. Another common connection to the satellite set-top-box 100 is a phone line 126. The phone line 126 can be used by the satellite set-top-box 100 to communicate with one or more outside entities or systems. These communications may include requesting pay-per-view programming, obtaining updates to subscriber programming, or receiving updates to software on the satellite set-top-box 100. One skilled in the art will recognize that there are many other uses for this phone line connection. Also, one skilled in the art will recognize that this phone line 126 may represent other communication media, including, but not limited to, wireless, internet, or microwave. One function of the phone line may be to receive periodically the EPG data.

A satellite set-top-box 100 may be connected to one or more peripheral electronic devices. These peripheral devices may include a stereo (not shown), a television 120, a VCR (not shown), or like devices. These devices may receive signals from the satellite set-top-box 100 or send signals to the satellite set-top-box. For instance, the television 120 may receive video and audio signals. The stereo may receive only audio signals. A camcorder (not shown), on the other hand, may send video or audio signals to the satellite set-top-box 100. The peripheral devices may include any type of commercially available electronic device.

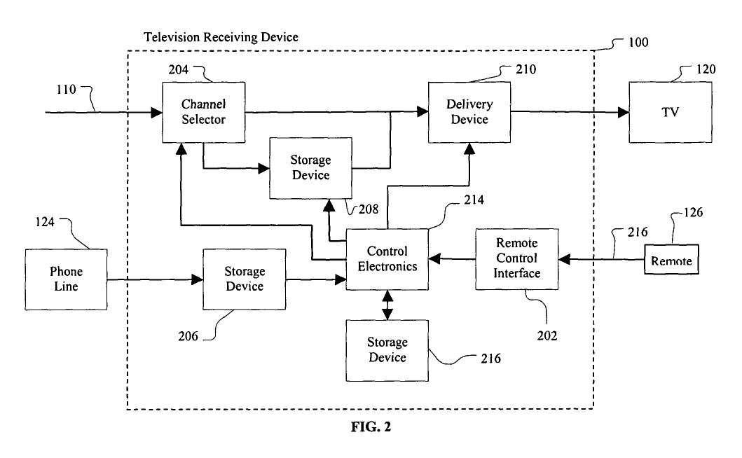

FIG. 2 provides a high level block diagram for a satellite set-top-box embodiment of a television receiver 100 in accordance with the present invention.

The operation of the satellite set-top-box is controlled by control electronics 214. The control electronics 214 are connected to the remote control interface 202, the channel selector 204, three storage devices 206, 208, and 216, and the delivery device 210. The control electronics 214 may be any of a multitude of commercially available processors such as the Motorola™ 68000 or a processor from the Intel™ Pentium™ family. In addition, the control electronics 214 may be any type of custom ASIC, such as from the LSILogic G11 family, or FPGA, such as from the Altera Stratix™ family. In addition, the control electronics 214 may include discrete electronic components combined into a single circuit. The control electronics 214 may operate under the control of a software program, firmware program, or other program stored in memory or control logic. One skilled in the art will recognize that other embodiments of the control electronics 214 are possible.

The satellite set-top-box may also include one or more channel selectors 204. The channel selector 204 is the device or devices that processes the signal 110 provided by the satellite communication device 108. In other words, the channel selector 204 may include demodulators, decoders, demultiplexers, and data packet selectors. One skilled in the art would recognize that the channel selectors 204 may include fewer, more, or different components. The term channel selector 204 is used herein to avoid confusion and remind the reader that the invention applies equally to analog and digital television receiver 100.

In one embodiment, the satellite set-top-box 100 may include a delivery device 210. This device includes components for transmitting a television signal from the channel selector 204 or the storage device 208 to the television 120. Thus, the delivery device 210 may include, but is not limited to, any digital to analog converters (DAC), electronic video drivers, video filters, or other electronic device to send television signals to a television 120 or other video display device. The output of the delivery device 210 may be an analog television baseband signal, a modulated television signal (e.g., modulated on channel 3 or 4 for reception by a television that has no baseband input), or a digital output.

The satellite set-top-box 100 may also contain one or more storage devices 206, 208, and 216. The storage devices 206, 208, and 216 are capable of receiving and storing data whether it be television programming or system data including software. Furthermore, the storage devices 206, 208, and 216 may be further adapted to retrieve any stored data, and deliver it to other devices within the set-top-box or directly to connected peripherals. The storage devices may include, but are not limited to, optical storage medium like CDs, hard drives, RAM, ROM, electro-optical storage devices, and magnetic media like tapes. Storage devices will preferably be some type of randomly accessible, nonvolatile storage medium.

A first storage device 208, typically a hard drive, can record and store programming provided by one or more channel selectors 204. Furthermore, the hard drive may retrieve stored programs and deliver them to the delivery device 210. The hard drive is also connected to the control electronics 214, which, in some embodiments, may control the hard drive.

A second storage device 206, typically RAM, can receive and store EPG data. The EPG data may be transmitted to the RAM via the phone line 124 (as shown) or in the satellite television signal 110. The second storage device 206 may also include any device to separate EPG data from the data stream 110 coming from the satellite content provider 104. These devices may include the same devices as in the channel selector 204. Alternatively, this could be done within the channel selector 204. In one embodiment, the EPG data may come from the content provider, for instance, the satellite content provider 104. In another embodiment, the EPG data may come from the broadcaster, for instance, ABC™. In yet another embodiment, the EPG data may come from a third party, such as TV Guide™. One skilled in the art will recognize that the EPG data may be transmitted to the RAM by various other methods, by other systems, or from other outside entities. The RAM may also be connected to the control electronics 214. The RAM would provide access to the EPG data via the control electronics 214. Further, the RAM may be connected (not shown) to the delivery device 210 for display on the TV as a programming schedule.

An embodiment of the present invention may also include a third storage device 216. This storage device 216 may store timers created by the control electronics 214. This storage device 216 may also store other commands or functions for the control electronics 214.

The satellite set-top-box may include a remote control interface 202. This remote control interface 202 may include any device for the user to communicate to the satellite set-top-box. In a preferred embodiment, this remote control interface 202 can receive commands from a remote control 126. The remote control interface 202 may include any device to translate an input from the user into a format understandable by the control electronics 214. The translation systems may include, but are not limited to, electronic receivers and electronic relays. One skilled in the art will recognize that other devices to receive and translate user inputs are possible.

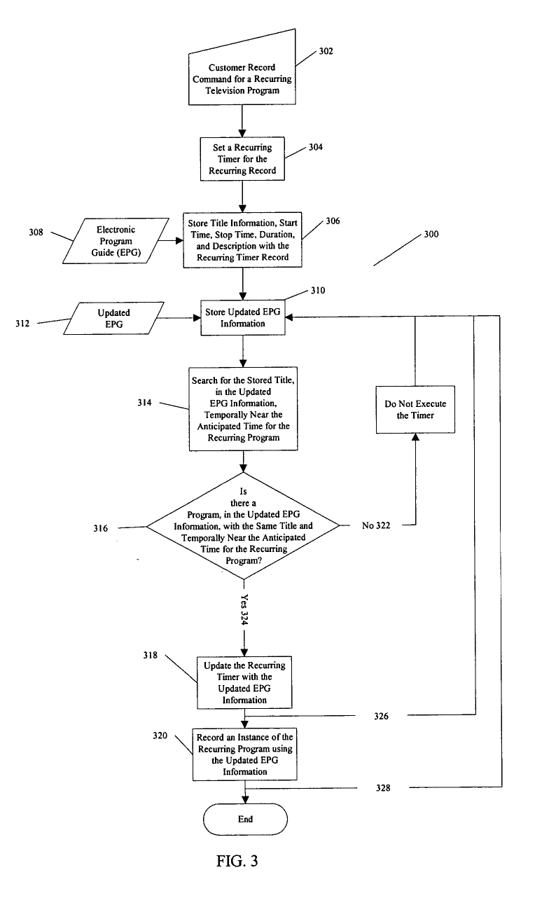

FIG. 3 shows the logical steps of the general method 300 of setting and updating, for a television receiver 100, a recurring timer for a recurring television program. A recurring television program is a television program that plays periodically on a service provider. For instance, the program “Alias” plays weekly on Sunday at 8:00 p.m. on the service provider ABC™. Thus, “Alias” is a recurring television program with a periodic showing once a week. Recurring television programs may have different periods, including but not limited to, daily, weekly, monthly, or every weekday. One skilled in the art will recognize that there are other variations of the recurring television program and its period of occurrence.

A recurring timer is a timer that allows a television receiver 100 to record episodes of the recurring television program. The recurring timer has the effect of starting a recording at every instance (episode) of the recurring television program. Thus, if “Alias” is shown once-a-week, the recurring timer will execute a record of “Alias” every week. Recurring timers follow or match the period of the recurring television programs. Thus, the period of the recurring timer may include, but is not limited to, daily, weekly, monthly, every weekday. One skilled in the art will recognize that as different recurring television programs may be possible the different recurring timers with different periods are also possible.

In one embodiment, the user punches keys on the remote control 126 to send a record command 302 to the satellite set-top-box 100. For the present invention, the user record command 302 requires the satellite set-top-box 100 to record a recurring television program. For example, the user commands the satellite set-top-box 100 to record every Sunday from 8:00 to 9:00 p.m. In other embodiments, the user record command could require the satellite set-top-box 100 to record every day, every week, every month, or every weekday. One skilled in the art will recognize that the record command 302 may include many different variations of frequency for the recurring television program.

The control electronics 214 set a recurring timer that reflects the user's request 304. This recurring timer is stored in the storage device 216. In one embodiment, this recurring timer 304 can be a clock that counts down to the next record. In another, the recurring timer 304 is a data record or file. That data record includes information from the EPG.

The EPG data is a set of programming information. That information may include, but is not limited to, one or more of the following data: the program title, start time, stop time, duration, or description such as an episode title, season, number, identifier or plot summary. In an embodiment, the EPG data is updated periodically and frequently. This data can be retrieved from EPG stored in the storage device 206 for use by control electronics 214. The control electronics 214 creates the recurring timer data record by extracting information from the EPG, and storing it as part of the recurring timer 306. The information stored in the recurring timer data record may include, but is not limited to, program title, start time, stop time, duration, or description.

At some point after the creation of the recurring timer, the storage device 206 can receive and store 312 updated EPG data from the satellite link 110. In one embodiment, this EPG data may arrive at the satellite set-top-box 100 periodically including, but not limited to, daily, weekly, or monthly. The EPG data may also be transmitted to the storage device 206 after a change occurs in the EPG data. Also, in one embodiment, the EPG data may arrive before each instance of the recurring television program to be recorded by the recurring timer. The satellite set-top-box 100 then stores 312 the updated EPG information in the storage device 206. Storing the EPG information may also occur in a unit separate from the satellite set-top-box 100.

In one embodiment, upon storing the updated EPG data, the control electronics 214 is informed that new EPG data has arrived. The control electronics 214 then retrieves the EPG data from the storage device 206 and begins to search 314 the updated EPG information for information that corresponds to the recurring timers. In another embodiment, the control electronics 214 periodically searches 314 for information that corresponds to the recurring timer. Thus, the control electronics 214 searches the presently available EPG and does not search upon being notified of receipt of a new EPG. The frequency of this periodic search 314 may be, but is not limited to, once a day, once a week, once a month. The search normally entails looking for some common identifier for every episode of the recurring television program.

In an embodiment, the control electronics 214 looks for the program title in the EPG data. The search may find instances of the program that are not related to the time the recurring program was to record. Thus, this search 314 may find programs that the user did not want to record. In a preferred embodiment, the control electronics 214 searches 314 for the title, in the updated EPG data, temporally near the anticipated time of the recurring program the user desires to record, i.e., the temporal search parameters are affected by the contents of the timer. In addition to temporal searching, the search may or may not be limited to specific virtual channels.

In one embodiment, this temporal search 314 involves searching for titles a period of time either at, before, after, or overlapping the anticipated time the user requested the recurring record. In one embodiment, this search 314 would be done by time. For instance, the search 314 would be one hour before the 8:00 p.m. start time, one hour after the 9:00 p.m. stop time, or three hours overlapping the 8:00 p.m. start time, the 9:00 p.m. stop time, or both the start and stop time. One skilled in the art will recognize that the satellite set-top-box 100 may search 314 by any set period of time, including but not limited to, one hour, 30 minute, or 15 seconds, Also, the search 314 may occur before, after, or overlapping the anticipated time the program is normally shown.

In another embodiment, the temporal search 314 would be by timeslot. A timeslot would be a block of time in which that program is shown. For example the timeslot may be 30 minutes, one hour, or two hours. One skilled in the art will recognize that the duration of the timeslot selected can be a different duration than those listed above. The search 314 would cover some number of timeslots before, after, or overlapping the anticipated timeslot of the recurring program to be recorded. For instance, the control electronics 214 not only searches for the program title at 8:00 p.m., but also checks for the title in a one one-hour timeslot before, 7:00 p.m. to 8:00 p.m., the time slot after, 9:00 p.m. to 10:00 p.m., or three timeslots overlapping the 8:00 p.m. to 9:00 p.m. timeslot. The number of timeslots searched may vary.

In yet another embodiment, the temporal search 314 is not by time or time slot but by program slot. A program slot is the place the program occupies in a sequential order of programs to be shown on that channel, i.e. ABC™ shows, on Sunday nights, first, the DISNEY™ Movie, second, “Alias”, and third, “Dragnet”. The control electronics 214 searches 314 for the program title at its slot in the programming from 8:00 p.m. to 9:00 p.m. Then, the satellite set-top-box 100 checks the program slot or slots that precede, follow, or overlap the program slot for the recurring program. One skilled in the art will recognize that the satellite set-top-box 100 may search 314 any number of program slots before, after, or overlapping the recurring program's normal program slot. Also, one skilled in the art will recognize that the program slot may be of different duration, including but not limited to, two hours, one hour, 30 minutes, or 15 minutes.

If the control electronics 214 finds a title that is temporally near the anticipated time for the recurring program 316, the control electronics 214 then updates the recurring timer. This situation is shown by branch 324. If the control electronics 214 does not find a title that is temporally near the anticipated time for the recurring program 316, the satellite set-top-box 100 does not execute the timer 330. Instead, the control electronics 214 may search 314 again at some time in the future. This situation is represented by branch 322. In one embodiment, the updating 318 of the recurring timer includes the replacement of the information stored 306 within the recurring timer data record. The information replaced may include, but is not limited to, the program start time, the stop time, or the duration. This replacement would mean the deletion of the old information stored with the recurring timer data record, and storing new, updated information in the data record.

In another embodiment, the updating 318 of the recurring timer actually requires the creation of a new timer for the instance of the recurring program. The recurring timer can function as a search device that looks for instances of the desired program. If an instance is found, the control electronics 214 creates the new timer. The creation of the new timer would entail the same steps as setting the recurring timer 304 and storing the recurring timer 306. The difference would be that the information stored with this new timer would come from the updated EPG information, and this new timer, may or may not be updated.

After the update, the satellite set-top-box 100 records the instance of the desired program 320 using the updated information in the recurring timer. These recordings 320 would repeat according to the period of the recurring program. In a preferred embodiment, each instance of the record 320 would be executed using updated EPG information specific to that instance. However, one skilled in the art would recognize that the recurring timer may not be updated before recording 320 every instance of the recurring program. One skilled in the art will also recognize that the recurring timer may get updated more than once before recording 320 an instance of the recurring program. This situation is depicted by branch 326. After a recording 320, the updating of the recurring timer may occur again. This situation is represented by the branch 328.

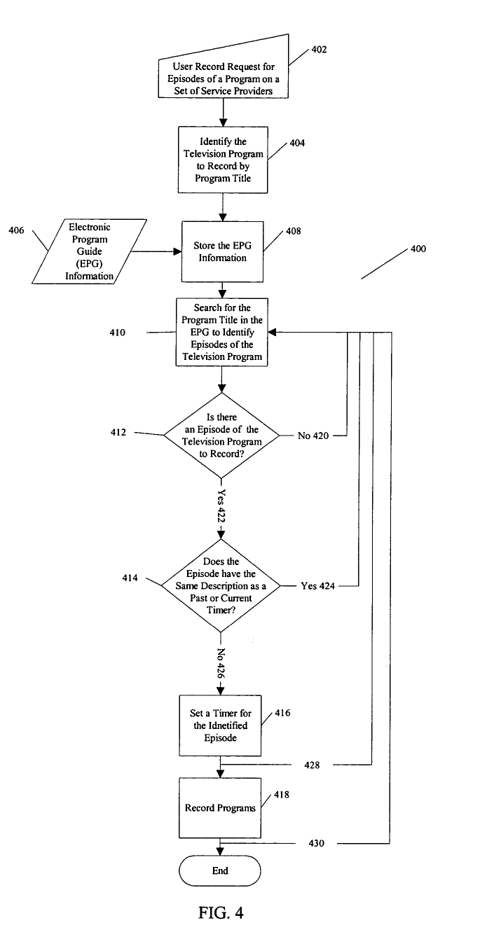

Another embodiment of the invention is represented in FIG. 4. This embodiment is a method 400 for creating a timer on the satellite set-top-box 100 that records multiple episodes of the same program. An episode is an instance of the television program. Each episode is a different story in the program. For instance, ABC™ may show the “Alias” episode titled “Firebomb” one week, and the episode titled “A Dark Turn” the next week.

It is also possible that a program may play on several channels, usually as a result of syndication. Thus, in the future, newer episodes of “Alias” may play on ABC™, while older episodes may play on, WB™. One skilled in the art will recognize that episodes of a single program may play on any number of different channels.

The user sends a record request 402, via the remote control 126, to the satellite set-top-box 100. In one embodiment, this request 402 requires the control electronics 214 to record all episodes of a television program playing on a set of channels one or more channels. The control electronics 214 then identifies 404 the television program the user desires to have recorded. In a preferred embodiment, this identification 404 requires the control electronics 214 to use the program title as a common identifier for all episodes of the program to be recorded. One skilled in the art will recognize that other identifiers may be used that could associate the television program with the user's record request. The identification 404 can also be done manually or automatically. In one embodiment, the user manually selects a program title or other identifier to use with the record request. In a preferred embodiment, the control electronics 214 automatically selects the identifier, program title or otherwise, to associate with the record request.

The control electronics 214 also retrieves EPG data 406 from the second storage device 206. As explained above, this EPG data may arrive periodically. In a preferred embodiment, the EPG data is received 406 by the storage device 206 after the addition of an episode to the EPG. The storage device 206 stores the EPG information 408.

The control electronic 214 then utilizes 410 the EPG information to identify future episodes of the television program. In one embodiment, upon storing the updated EPG data, the control electronic 214 is informed by the storage device 206 that new EPG data has arrived. The control electronic 214 then begins to search 410 the updated EPG information for the common identifier that corresponds to an episode of the television program. In another embodiment, the control electronic 214 periodically searches 410 the EPG information that is currently stored in the satellite set-top-box 100. In other words, the search 314 is not triggered by the receipt of the EPG data, but by a separate timer. The frequency of this periodic search 410 may be, but is not limited to, once a day, once a week, once a month. One skilled in the art will recognize that the searches 407 may be accomplished by other methods.

The common identifier used in the search 410 may vary. In a preferred embodiment, the satellite set-top-box 100 searches 410 the EPG for the program title that corresponds to the future episodes of the television program. One skilled in the art will recognize that other embodiments may use other common identifiers to search 410 for episodes of the television program. These searches 410 may also encompass searching programs to be played on a set of channels.

As stated before, a search may be accomplished on one or more channels. This set of channels may be predetermined. Predetermination would mean that the set of channels is selected by the user. The predetermination can also be by the control electronics 214. In other words, the user may manually select which channels to search or the system may select automatically which channels to search for episodes. In one embodiment, the control electronic 214 could accomplish the automatic selection by searching the EPG information once, and selecting all channels that had played or will play an episode of the television program. One skilled in the art will recognize that other methods are available to accomplish the selection of the set of channels.

The control electronic 214 can determine if the search found an episode to record 412. If there is an episode to record, branch 422, the control electronics 214 proceed to determine if that episode has been or will be recorded 414. However, if the search does not identify an episode to record, branch 420, the control electronics 214 will continue the search 410 either on the existing EPG information or on updated EPG information.

After the satellite set-top-box 100 determines that there is an episode to record, the control electronics 214 determine if that episode has been recorded or will be recorded 414. To make this determination, the satellite set-top-box 100 will compare some episode identifier with that same episode identifier on old records or new timers. Thus, in one embodiment, the control electronics 214 stores, in the storage device 216, the episode identifier with the new timers that will be used to record. These identifiers may be the episode description. In another embodiment, the episode title may be used. One skilled in the art will recognize that other identifiers are available. If the episode identifiers are the same for the current episode and an already existing timer, the control electronics 214 does not create a new timer, branch 424. By checking that two timers are not set for episodes with the same description, the control electronics 214 prevents the copying of identical and duplicate copies of the same episode.

In another embodiment, the control electronics 214 may archive a data record of past recordings. Thus, the control electronics 214 can save copies of past, executed timer. These timers may include an episode description. In an embodiment, the control electronics 214 would find an episode in the EPG, and it would check the episode description in the EPG against the episode description of the archived timers. If episode description is the same as any executed timer, the recording device does not create a new timer, branch 424. However, if the episode descriptions differ, the satellite set-top-box 100 does set a new timer, branch 426.

Additionally, the control electronics 214 may save, in the storage device 216, a simple file that includes only episode descriptions of past recordings. The control electronics 214 would check against the list of episode descriptions. If the present episode description and a description in the list are the same, no timer is created, branch 424. One skilled in the art would recognize that other methods are available to check archived timers. The control electronics 214 may check any number of previous recordings. The number of previous recording checked may be defined by a temporal limit. For instance, only past recording from the last three weeks may be checked. One skilled in the art will recognize that the check may search all records that have executed any period of time before the present time.

Also, the control electronics 214 may also check against current timers that have already been created but are unexecuted. In a preferred embodiment, the satellite set-top-box 100 saves timers with an episode description included. The control electronics 214 then would find an episode description in the EPG, and it would check that episode description against the episode descriptions stored with the existing, unexecuted timers. If the description is the same as an unexecuted timer, a subsequent timer is not created. In another embodiment, the satellite set-top-box 100 would create the subsequent timer, and then check if another timer has the same episode description. If two timers have the same episode description, the satellite set-top-box 100 would delete one or the other timer, preferably, the older timer.

After these checks are made, the control electronics 214 sets a timer for any episode that needs to be recorded 416. In one embodiment, this recurring timer can be a clock that counts down to the next record. The recurring timer may also be a data record or a data file. That data file includes information from the EPG. The control electronics 214 creates the data record by extracting information from the EPG and storing it as part of the recurring timer 416. The information stored may include, but is not limited to, a channel, a time period, a program title, or an episode description. The time period may be represented by a start and stop time, a start time and duration, or a stop time and duration. One skilled in the art would recognize that the time period may be represented by other metrics.

The control electronics 214 may set the timers in different ways. In one embodiment, control electronics 214 creates a first timer for one episode of the program. Upon that timer triggering a record of the episode, the satellite set-top-box 100 searches for the next episode and resets that timer to record the next episode. The resetting operates to replace the old timer with the new timer. In this manner, only one timer may be active at any time.

In another embodiment, the satellite set-top-box 100 creates a new timer for every episode to be recorded. Essentially, the satellite set-top-box 100 creates a first timer for a first episode to be recorded, creates a second timer for a subsequent episode, and creates a timer for each episode that follows. Each of these timers functions independently. This independence means that the timers are each capable of individually causing a record of an episode. Each timer functions separate from the other timers. There is no relation of one timer to another. If one timer executes, it does not cause the other timers to execute. If one timer is deleted or changed, the other timers remain the same. In this manner, the control electronics 214 may store several different timers. This embodiment may be preferred if the episodes are to be recorded on more than one channel because two episodes on two different channels may play at the same time. Without two different timers, one recording will not be made. One skilled in the art will recognize that other methods are possible for the setting of these timers.

In this embodiment, the satellite set-top-box may also create a recurring timer indicator record that indicates what television program is to be recorded. A user viewing the list of timers on the set-top-box may only see the recurring timer indicator record, rather than the list of all the currently existing episode timers for that program. One skilled in the art will recognize that other methods are possible for communicating the existence of a recurring timer to a user.

It will be clear that the present invention is well adapted to attain the ends and advantages mentioned as well as those inherent therein. While a presently preferred embodiment in the form of a satellite set-top-box has been described for purposes of this disclosure, various changes and modifications may be made which are well within the scope of the present invention. For example, an additional algorithm could be included that resolves conflicting timers automatically by switching one of the timers to an identical episode at a different time. Numerous other changes may be made which will readily suggest themselves to those skilled in the art and which are encompassed in the spirit of the invention disclosed and as defined in the appended claims.

1. A method of updating a recurring timer for a television recording device for a recurring television program, comprising the steps of:
a. receiving and storing, for the television recording device updated electronic program guide information;
b. setting, for the television recording device, the recurring timer for the recurring television program including storing the anticipated service provider, time period, and title; and,
c. prior to an instance of the recurring television program to be recorded, using the stored title information and the updated electronic program guide information to update the recurring timer for that instance.

2. A method according to claim 1, wherein the television recording device uses the stored title to find the instance of the recurring television program in the updated electronic program guide information.

3. A method according to claim 2, wherein the instance of the recurring program is found by comparing the stored title to the titles of programs in the updated electronic program guide information temporally near the anticipated time on the anticipated service provider.

4. A method according to claim 3, wherein searching near the anticipated time includes searching at times before, after, or overlapping the anticipated time.

5. A method according to claim 4, wherein the temporal search includes searching timeslots.

6. A method according to claim 4, wherein the temporal search includes searching program slots.

7. A method according to claim 4, wherein the temporal search includes searching a period of time.

8. A method of creating a timer for a television recording device for multiple episodes of a television program, comprising the steps of:
a. receiving and storing, for the television recording device updated electronic program guide information;
b. identifying the television program to record;
c. utilizing the electronic program guide information to identify future episodes of the television program occurring on a set of service providers; and,
d. setting timers for at least some future episodes.

9. A method according to claim 8, wherein the setting of timers includes the setting of a first timer for a first episode and setting a second timer for a subsequent episode.

10. A method according to claim 9, wherein the first and second timers function independently.

11. A method according to claim 9, wherein the second timer replaces the first timer after the first timer executes.

12. A method according to claim 8, wherein the set of service providers is a single service provider.

13. A method according to claim 8, wherein the television recording device identifies an episode by searching for a program title in the electronic program guide information that matches the program title for the identified television program.

14. A method according to claim 8, wherein the television recording device stores for each timer a service provider, a time period, the program title.

15. A method according to claim 14, wherein the television recording device stores for each timer an episode description.

16. A method according to claim 15, wherein duplicate copies of the same episode are not recorded by not setting a timer for subsequent episodes with a same episode description as a past or future timer.

17. A method according to claim 16, wherein the past and future timers are archived.

18. A method according to claim 17, wherein the archived timers include only the episode description information.

19. A method according to claim 15, wherein the television recording device compares the episode description in the electronic program guide information with the episode description stored with an unexecuted current timer and not creating a subsequent timer if the episode descriptions are the same.

20. A method according to claim 12 wherein the television recording device compares the episode description in the updated electronic program guide information with the episode description stored with an executed timer and not creating the subsequent timer if the program descriptions are the same.

21. A television receiving device for recording recurring programs with a recurring timer, comprising
a. a television signal receiver to receive and process television signals;
b. a remote control interface to receive a user record request sent from a remote control;
c. a telecommunications interface to receive updated electronic program guide information;
d. a first storage device coupled to the telecommunications interface to store the updated electronic program guide information;
e. a second storage device coupled to the television signal receiver to store the television program to be recorded;
f. a third storage device; and,
g. a processor coupled in communication to the television signal receiver, the remote control interface, the first storage device, the second storage device, and the third storage device, wherein, the processor obtains a program title provided by the user via the remote control, sets a timer for the television program, saves the timer in the third storage device, searches for the program title in the updated electronic program guide information in the first storage device, finds an instance of the television program, updates the timer for the television program, executes the timer by sending a record command to the first communications and the second storage device according to the updated timer.

22. An apparatus according to claim 21, wherein the first storage device, second storage device, and third storage device are nonvolatile, randomly accessible recording media.

23. An apparatus according to claim 21, wherein the television signal receiver comprises one or more of a satellite dish, an low-noise block filter, a switch, a downconverter, a demodulator, a demultiplexer, or a decoder.

24. An apparatus according to claim 21, wherein the remote control interface receives remote control signals as infrared or UHF frequencies.

25. An apparatus according to claim 21, wherein the television receiving device further comprises a television display driver for transmitting television signals to a television for viewing by the user.

26. An apparatus according to claim 21, wherein the television signal receiver is attached to one of a cable television distributor, a satellite television distributor, or a broadcast television provider.

27. A satellite set-top-box for recording recurring programs with a recurring timer, comprising:
a. a channel selector to receive and process television signals;
b. a remote control interface to receive a user record request sent from a remote control;
c. a first storage device to store the updated electronic program guide information;
d. a second storage device coupled to the channel selector to store the television program to be recorded;
e. a third storage device; and,
f. a processor coupled in communication to the television signal receiver, the remote control interface, the first storage device, the second storage device, and the third storage device, wherein, the processor obtains a program title provided by the user via the remote control, sets a timer for the television program, saves the timer in the third storage device, searches for the program title in the updated electronic program guide information in the first storage device, finds an instance of the television program, updates the timer for the television program, executes the timer by sending a record command to the first communications and the second storage device according to the updated timer.

28. An apparatus according to claim 27, wherein the first storage device, second storage device, and third storage device are nonvolatile, randomly accessible recording media.

29. An apparatus according to claim 27, wherein the channel selector comprises one or more of a satellite dish, an low-noise block filter, a switch, a downconverter, a demodulator, a demultiplexer, or a decoder.

30. An apparatus according to claim 27, wherein the remote control interface receives remote control signals as infrared or UHF frequencies.

31. An apparatus according to claim 27, wherein the satellite set-top-box further comprises a delivery device for transmitting television signals to a television for viewing by the user.

32. An apparatus according to claim 27, wherein the satellite set-top-box receives digital data on at least one carrier signal from a satellite.

33. An apparatus according to claim 27, wherein the first, second, and third storage devices comprise different partitions on a single data storage device.

34. A method on a satellite set-top-box of updating a recurring timer for a recurring television program, comprising the steps of:
a. receiving and storing, by the satellite set-top-box, updated electronic program guide information;
b. setting the recurring timer for the recurring television program including storing the anticipated service provider, time period, and information identifying the recurring television program; and,
c. prior to an instance of the recurring television program to be recorded, using the stored information identifying the recurring television program and the updated electronic program guide information to update the recurring timer for that instance.

35. A method according to claim 34, wherein the television recording device uses the stored information identifying the recurring television program to find the instance of the recurring television program in the updated electronic program guide information.

36. A method according to claim 35 further comprising:
d. comparing a stored title to titles of programs in the updated electronic program guide information temporally near the anticipated time on the anticipated service provider.

37. A method according to claim 36, further comprising:
e. searching near the anticipated time including searching at times before, after, or overlapping the anticipated time.

38. A method according to claim 37, wherein seaching includes searching timeslots.

39. A method according to claim 37, wherein searching includes searching program slots.

40. A method according to claim 37, wherein seaching includes searching a period of time.
